(19) United States
(12) Patent Application Publication
(10) Pub. No.: US 2011/0082875 A1
(43) Pub. Date: Apr. 7, 2011

(54) SYSTEM AND METHOD FOR DYNAMIC PAYLOAD GENERATION ON SHARED SITES

(75) Inventor: Bruce Bissett, Centennial, CO (US)

(73) Assignee: NETQUOTE, INC., Denver, CO (US)

(21) Appl. No.: 12/573,047

(22) Filed: Oct. 2, 2009

(51) Int. Cl. G06F 15/16; G06F 17/30; G06F 17/00

(52) U.S. Cl. 707/769; 709/219; 715/234; 707/E17.014

(57) ABSTRACT

A computer-based system and method for generating a user-requested resource including, in embodiments, a web server farm to communicate with a network and a content source, a parse facilitator to parse a URL received through the network from a browser of a user computer, and a payload determinator to use at least the received URL to identify and retrieve one or more controls from the content source. The system and method may also include a payload constructor to retrieve components uniquely associated with the retrieved one or more controls and assemble a user page using the retrieved components, where the payload constructor is used for any unique received URL, and for assembling one or more user pages associated with any unique URL. The system and method may further include a launch facilitator to forward the assembled user page to the browser of the user computer through the network.

### FIELD OF INVENTION

The present invention relates to constructing dynamic payload for one or more network sites according to a received URL.

### BACKGROUND

Traditionally, a website is created by writing HTML files for each page of the website. Creating each of these HTML files can be time-consuming. When an organization is operating multiple websites, the organization may need to devote significant resources creating HTML files for each page of each website. Moreover, each website may have related content and functional items. Accordingly, when there is a change to one of the related content items in one of the websites, the organization may need to devote additional resources to making that change to each of the content items for each website. Additionally, when the pages are designed and constructed, they are stored on files on a server. However, these files are static and remain the same unless a designer takes the time-consuming task of going through each page and making changes.

### SUMMARY OF INVENTION

Embodiments of the present invention relate to systems and methods for constructing web pages having a distinct look and feel, and yet each web page may use one or more content items andto Bror functionality that are reusable from one web page to another web page. The web pages may be constructed by a web system located on a server. The web system may be configured to receive multiple URLs associated with one or more domain names, and may be configured to parse the URL for at least a domain name, a path, a filename, and URL parameters and retrieve content associated with at least the determined domain name and URL parameters. The domain name may be associated with a brand that indicates a particular look and feel. Further, the web system may be configured to build the page using the retrieved content. The retrieved content may include controls that invoke one or more functions included in a core set of functions of the web system. The one or more functions may be used to operate on the content when the web system is building the page. The specific set of controls and functions used to build the page may depend on the brand associated with the domain name. Additionally, the controls and functions may be reused from one page to another page and across sites. The web system may also be configured to return HTML to a user requesting the page.

Embodiments are directed towards a computer-based system for generating a user-requested resource. The system may include a web server farm configured to communicate with a network and a content source. The system may further include a parse facilitator configured to parse a URL received through the network from a browser of a user computer. The system may further include a payload determinator configured to use at least the received URL to identify and retrieve one or more controls from the content source. The system may further include a payload constructor configured to retrieve components uniquely associated with the retrieved one or more controls and assemble a user page using the retrieved components, wherein the payload constructor may be used for any unique received URL, and for assembling one or more user pages associated with any unique URL. The system may also include a launch facilitator configured to forward the assembled user page to the browser of the user computer through the network.

### BRIEF DESCRIPTION OF THE DRAWINGS

FIG. 1 illustrates an example computer network topology diagram;

FIG. 2 illustrates an example server system;

FIG. 3 illustrates an example web system;

FIG. 4. illustrates an example database brand table;

FIG. 5 illustrates an example database partner table;

FIG. 6 illustrates an example session profile;

FIG. 7 illustrates an example homepage for a first brand;

FIG. 8 illustrates an example auto insurance page for the first brand;

FIG. 9 illustrates an example homepage for a second brand;

FIG. 10 illustrates an example auto insurance page for the second brand;

FIG. 11 illustrates an example flow chart for constructing a page using content associated with a received URL;

FIG. 12 illustrates an expanded example flow chart for constructing a page using content associated with a received URL; and

FIG. 13 illustrates a schematic diagram of an example computing device.

### DETAILED DESCRIPTION

An organization may run multiple websites, where each website may have a unique look and feel and a unique set of services. Embodiments of the present invention relate to systems and methods for dynamically building web pages using content associated with a received URL. Elements of the URL may be used to identify a particular site and page within the site. The database may further be queried to determine which components are needed to construct the page. These components may include controls, content, images, etc. A page may be subsequently built using these retrieved components.

The received URL, which may also be referred to as a request, may be associated with a request for a particular page of a website run by the organization. In embodiments, a URL is received at a server having a web system. The web system may be configured to parse the URL to determine at least a domain name, a file, a path, and one or more URL parameters. The domain name may be associated with a website having a particular look and feel such as that which might be associated with e.g., a “brand,” where the brand may be associated with the organization. The brand may indicate a particular look and feel for a website. The organization may have multiple brands where each brand is associated with a different URL. Additionally, the one or more URL parameters may be associated with a partner, where the partner may indicate the source of the received URL, and may further refine the look and feel of the requested website.

The web system may be further configured to retrieve components (e.g., controls, content, images, styles) associated with at least the determined domain name and one or more URL parameters. As an example, the “look and feel” may be unique to the brand and partner associated with the domain name and one or more URL parameters, respectively. Additionally, the web system may be configured to build a page using the retrieved components. As discussed above, the retrieved components may specify the one or more controls that may invoke the core set of functions. The core set of functions may be included in the web system. The set of controls and functions used on a page may depend on the particular page and the brand associated with the domain name and may be configured to alter their behavior on a page by page basis.

Accordingly, the brand may influence the components that are presented on a page. Additionally, since controls and their corresponding functions may be reused from site to site and from one page to another, a change to the control or function in one page will change the control or function for all other pages using the control or function. Thus, time may be saved from changing controls in each individual page.

The term “configured” may refer to one or more elements or features that were built or set up to perform one or more desired functions. The term “payload” may refer to any content rendered to a user or a client.

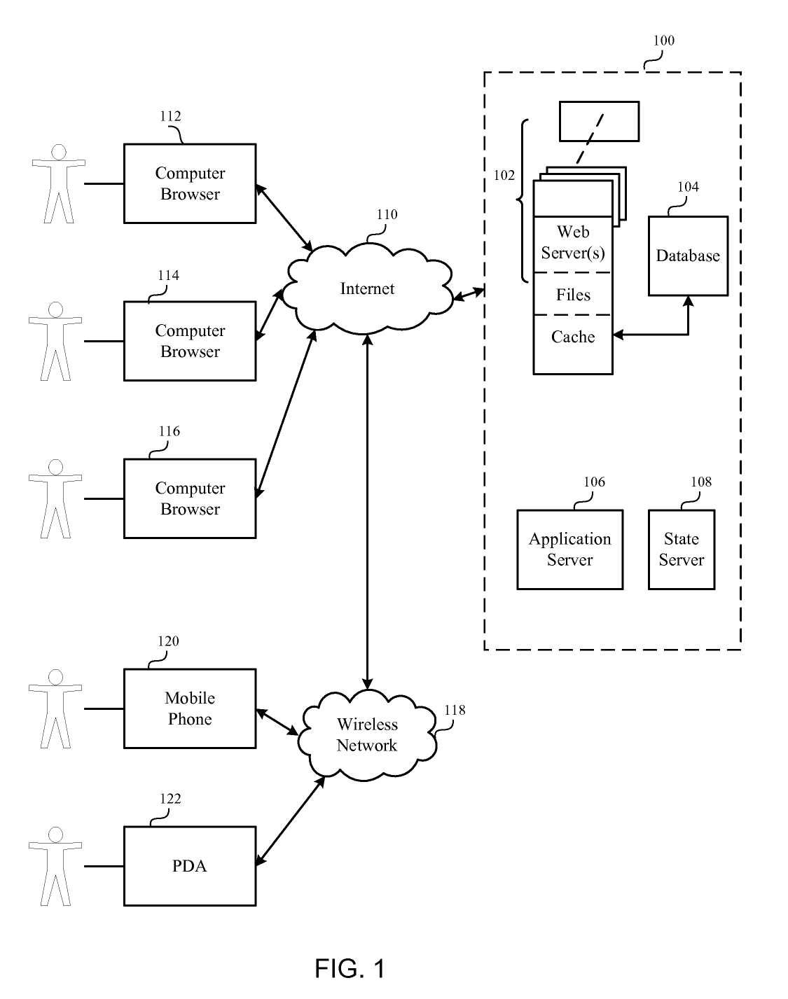

FIG. 1 illustrates an example computer network topology diagram for use as part of and in environments of embodiments of the present invention. In embodiments, the computer network may include a main system 100. The main system 100 may be operated by an organization operating multiple websites. The main system 100 may include a web server farm 102, a database 104, one or more application servers 106, and a state server 108. As an example, the web server farm 102 may include one or more servers in communication with each other. Additionally, each web server within the web server farm 102 may include a file system and a cache. In embodiments, the web server farm 102 may be configured to perform load balancing where work is distributed evenly among the servers within the web server farm 102. Each web server within the web server farm 102 may be in communication with the database 104, where each web server farm is configured to retrieve content from the database 104. The file system may be used to store files on each server in the web server farm 102.

According to some embodiments, the web server farm 102 may communicate with the one or more application servers 106. The application server 106 may include any desired supporting functionality to the main system 100 such as retrieving reference data that is volatile and that may change occasionally. Additionally, according to some embodiments, the web server farm 102 may communicate with the state server 108. In embodiments, the state server 108 may include any state information for the web server farm 102. As an example, the state information may indicate session information such as which users are currently communicating with the web server farm 102 and data specific to each user.

Each web server within the web server farm 102 may receive and transmit information from computer browsers 112 to 116 via an internet 110 (or other communication mechanism). In embodiments, each of the computer browsers 112 through 116 may be any desired browser that is configured to run on any user's personal computer. Additionally, each web server within the web server farm 102 may be configured to transmit and retrieve information to or from a mobile phone 120 or a personal digital assistant (PDA) 122 via a wireless network 118 that is in communication with the internet 110. In embodiments, any of the logic within the main system 100 may be implemented using any desired programming language such as C#. In alternative embodiments, logic within the web server farm 102 and application server 106 may be implemented in C# whereas the logic within the database 104 and the application server 106 may be implemented using any other desired programming language.

The term “module” refers broadly to a software, hardware, or firmware component (or any combination thereof). Modules are typically functional components that can generate useful data or other output using specified input(s). A module may or may not be self-contained. An application program (also called an “application”) may include one or more modules, andto Bror a module can include one or more application programs.

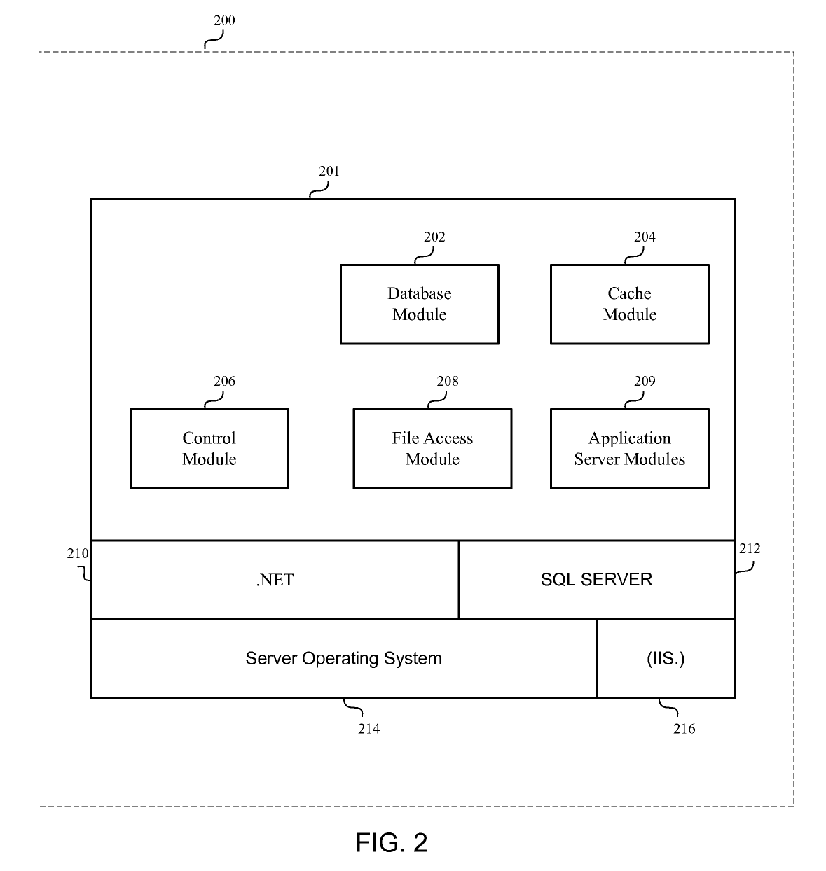

FIG. 2 illustrates an example server technology stack 200. In embodiments, the server technology stack 200 illustrated in FIG. 2 may reside across the system of servers (FIG. 1). In embodiments, the server technology stack 200 may include a control system 201 that includes one or more modules that operate within the control system. As an example, the control system 201 may include a database module 202. The database module 202 may be configured to access the database 104 (FIG. 1), which may run on a database 212 such as SQL Server, to retrieve content from the database 104, or store content on the database 104. In embodiments, the web system module 201 may include a cache module 204. The cache module 204 may be configured to cache information from the database 212 on each respective web server in the web server farm 102.

According to some embodiments, the control system 201 may include a control module 206. The control module 206 may be configured to operate on each incoming URL request such as parsing the incoming URL to determine at least the domain name and one or more URL parameters, retrieve content associated with the determined domain name and one or more URL parameters, operate on the retrieved content, and generate HTML. In embodiments, the control system 201 may include a file access module 208. The file access module 208 may be configured to retrieve or store files on each respective web server in the web server farm 102 (FIG. 1). In further embodiments, the control system 201 may include an application server module 209, which may be configured to perform any services required by the web server farm 102.

In embodiments, the server technology stack 200 may reside on top of Microsoft's .Net framework 210 from Microsoft of Redmond, Wash. The .Net framework may include a large library of coded solutions to common programming problems that can be used by the main system 100 (FIG. 1). As an example, modules within the server technology stack 200, such as the control module 206, may access this library of coded solutions to implement particular functions such as parsing an incoming URL. According to some embodiments, the server technology stack 200 may reside on top of an SQL server 212 (such as Microsoft SQL Server). The database module 202 may be configured to implement a desired query language used for querying a database 212. In embodiments, the database 212 operates as the database 104 (FIG. 1)

According to some embodiments, the .Net framework 210 and SQL server 212 may reside on a server operating system 214, such as the Windows Server 2003 operating system. A communication interface 216, such as the Internet Information Services (IIS), is provided by Windows Server Operating System 2003. The server operating system 214 may provide an operating structure for the .Net framework 210, SQL server database 212, and the server system 200. The communication interface 216 may be configured to provide communication functions for the control system 201 and .Net framework 210. As an example, the communication interface 216 may include the logic that facilitates communication between each of the servers in the web server farm 102 and the computer browsers 112 to 116 over the internet 110.

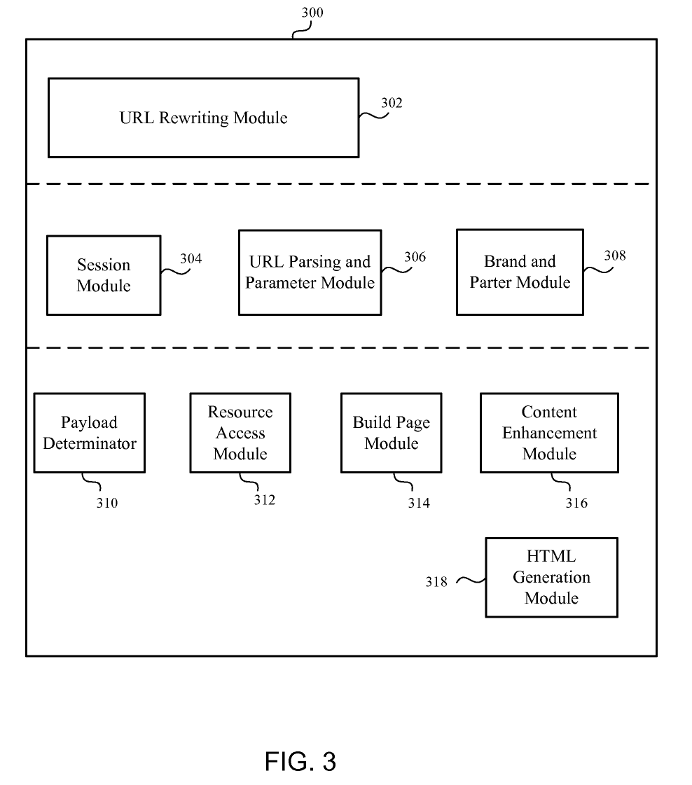

FIG. 3 illustrates an example control module 300. In embodiments, the control module 300 may be implemented within the control module 206 (FIG. 2). As illustrated in FIG. 3, the control module 300 may be segregated into three different layers.

In embodiments, the first layer may include a URL rewriting module 302. The URL rewriting module 302 may be configured to guide URL requests to a default page. As an example, for each incoming URL, the URL may specify a path which does not exist in the web server farm 102 (FIG. 1). As discussed above, web pages may be traditionally written in HTML and stored as a file on a server. A URL requesting this page may be specified as http:to Brto Brwww.example-domain.comto Brpage1.html. A server receiving this request may determine where the file for page1.html is located on the server and return that page to a user's computer browser. In the web server farm 102, the file page1.html may not exist. Accordingly, if the file page1.html does not exist, the URL rewriting module 302 directs this request to a default page such as default.aspx. In embodiments, the default page may not contain actual content but instead serves as a “controller” from which all functionality is centralized. This default page may be used to determine the page to build dynamically. According to some embodiments, the URL rewriting module 302 operates on each incoming URL.

In embodiments, the second layer of the control module 300 includes a session module 304, a URL parsing and parameter module 306, and a brand and partner module 308. The session module 304 may be configured to set up a session profile for each user (e.g., visitor) submitting a URL to the web server farm 102 (FIG. 1). As an example, the first time a user sends a URL request to the web server farm 102, the session module 304 sets up a session profile for that user, where the session profile may indicate a unique session identifier (hereinafter “ID”). In embodiments, a session is active if the user continues to send URL requests to the web server farm 102 within a predefined time period. The session module 304 may further be configured to store user data. As an example, if a user enters the user name and address in a web page, the session module 304 may store that information in the user's session profile in the state server 108.

The URL parsing and parameter module 306 may be configured to parse each incoming URL and determine at least a domain name, a path, a filename and one or more URL parameters associated with the URL. In embodiments, the URL parsing and parameter module 306 may operate as a parse facilitator. The brand and partner module 308 may be configured to determine a brand ID and a partner ID from the domain name and one or more URL parameters, respectively. In embodiments, a brand ID may be associated with a domain name of an incoming URL. As an example, an incoming URL may be specified as http:to Brto Brwww.BrandX.comto Brquotesto Brauto-insuranceto Brautoinsurance.aspxto Br?partnerID=P0. In this example, the URL parsing and parameter module 306 may determine that the domain name from this URL is www.BrandX.com, and the brand and partner module 308 may associate this domain name with a brand ID. Further, the URL parsing and parameter module 306 may identify partnerID=P0 as a URL parameter, which may be associated with a partner ID. Additionally, the URL parsing and parameter module 306 may identifyto Brquotesto Brauto-insurance as a path and auto-insurance.aspx as a filename. By parsing incoming URLs for at least a domain name and associating the domain name with particular websites, the web system 300 has the ability to receive URLs having multiple domain names. In embodiments, the modules illustrated in the second layer of the web system 300 may operate on the incoming URLs the first time a user requests the URL from the web server farm 102.

In embodiments, the third layer of the control module 300 may include a payload determinator 310, a resource access module 312, a build page module 314, a content enhancement module 316, and an HTML generation module 318. As an example, each brand and partner ID may be associated with a home page of a website. Additionally, a website may include multiple pages. Accordingly, an incoming URL may include a page name in the URL. The payload determinator 310 may use the page name to determine the appropriate page within a website to show, or may use other custom logic or user data to determine which page to show. The resource access module 312 may be configured to retrieve the determined page's controls and content from the database 104 (FIG. 1). In embodiments, each page may include a list of controls for the page. As an example, the list of controls may specify a content control, which may be a block of HTML that is inserted in the retrieved page. A content control may indicate where the retrieved content should be placed in the page. As an example, the retrieved content may include hyperlinks or images, and the content control may specify where these hyperlinks or images may be placed in the page. Another example of a control may be a user information control, which may include logic and functionality that verifies information provided by a user. As an example, a zip code control may be configured to received a zip code from a user and compare and validate the entered zip code with a zip code table in the database 104 (FIG. 1). In embodiments, pages retrieved by the payload determinator 310 may include any desired control having any desired functionality.

The retrieved content for the determined page may specify a skin file. A skin file may be used to configure the particular look and feel and configurable functionality for each control on a particular page. Skin files may be stored on a file system and may be processed automatically by the .Net Framework. The skin file may include directives associated with the look and feel of the page. As an example, the skin file may include a logo associated with a particular type of brand. Additionally, the skin file may specify colors and patterns for the borders of the page, where these colors and patterns may be associated with the brand specified for the page retrieved by the payload determinator 310. As an example, a skin file may turn a zip code control green and instruct the zip code control to not allow Texas zip codes.

The build page module 314 may be configured to iterate through the controls retrieved by the resource access module 312. The build page module 314 can customize each control based on page-specific configurations specified in the skin file for each control. In embodiments, the build page module 314 may include a functions library, where functions included in the function library may include logic for performing specific operations. As an example, as the build page module 314 operates on a zip code control, the build page module 314 may retrieve a function (e.g., zip code lookup function) that includes logic for verifying if a user entered a correct zip code. The content enhancement module 316 may be configured to iterate through each content control. As an example, a content control may include a place holder for a hyperlink or an image. Accordingly, as the content enhancement module 314 iterates through each content control, the content enhancement module 314 may retrieve content from the database 104 and replace a place holder with the retrieved content (e.g., hyperlink or image). In embodiments, the resource access module 312 and the build page module 314 and content enhancement module 316 may operate as a payload constructor.

The HTML generation module 318 may be configured to convert the page, after the build page module 314 and content enhancement module 316 have iterated through the controls inserted in the page, to HTML. In embodiments, the .Net Framework converts the page to HTML. In other embodiments, each control on the page may include logic to generate an HTML output. The HTML generation module 318 may operate as a launch facilitator.

The modules in the third layer illustrate the reusability of controls. Particularly, a control used to build one web page may be used to build another web page. Additionally, the modules in the third layer illustrate the advantage of avoiding redundant changes. Particularly, when there is a change to one of the controls or functions in the function library, that change will appear in all of the web pages utilizing the changed control or function. Accordingly, if 50 web pages use the changed control or function, the change in the control or function does not need to be made 50 times. According to some embodiments, the modules included in the third layer of the control module 300 may be configured to operate on each page retrieved by the payload determinator 310.

The following figures may be described with respect to an example organization, Insurance Corp, which provides insurance quotes to consumers. The organization Insurance Corp. may have a number of websites that provide insurance quotes to users. Each website may have a different domain name and different brand. Particularly, since each website may have a different brand, each website may have a different look and feel. As an example, Insurance Corp. may have the following websites: www.BrandX.com, www.BrandY.com, and www.BrandZ.com.

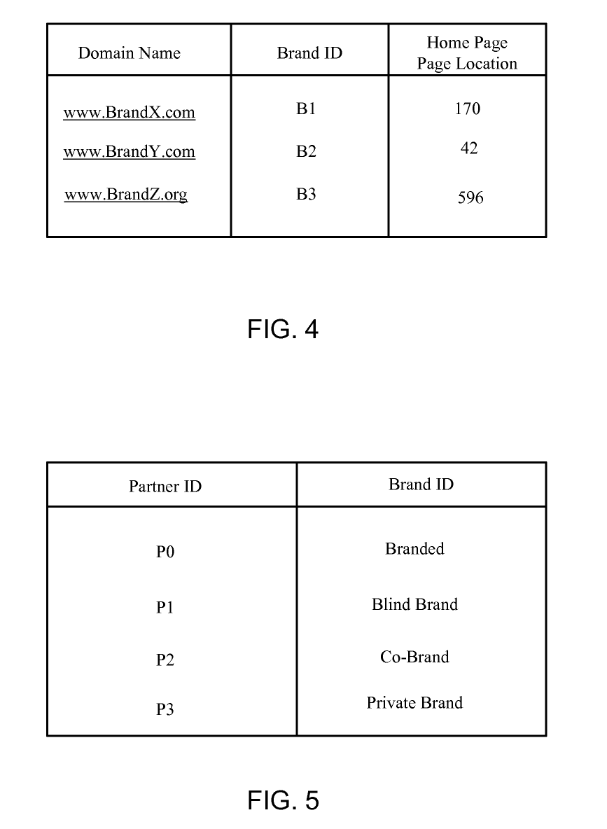

An example URL received by the web server farm 102 may be www.BrandX.comto Br?partnerID=P0. This example URL may be obtained by browsing a partner's website or search engines such as Google and clicking on a link for www.BrandX.com. Accordingly, upon clicking on the link, the text “to Br?partnerID=P0” may be inserted in the URL to indicate that there is a request for the domain name www.BrandX.com from a partner's website, where the partner is associated with the ID P0. From this received URL, the URL parsing and parameter module 306 may parse the received URL and determine that the domain name is www.BrandX.com. The URL parsing and parameter module 306 may further determine that the partner parameter in this URL is P0. After the domain name is parsed by the URL parsing and parameter module 306, the brand and partner module 308 may use the database table in FIG. 4 to associate the domain name with the brand ID B1, which has a home page located in the database 104 (FIG. 1) at address 170.

FIG. 4 illustrates an example database table associating a domain name with a brand ID and a home page location. As illustrated in FIG. 4, the database table lists the domain names associated with Insurance Corp. In embodiments, the table illustrated in FIG. 4 is located in the database 104 (FIG. 1). In embodiments, the table illustrated in FIG. 4 may be updated to include additional domain names that are associated with the web server farm 102 (FIG. 1) (e.g., www.BrandX.com).

FIG. 5 illustrates an example database table associating partner IDs with brand types. Partner ID's may be used to drive other alterations to the user interface, further affecting how the branding information is displayed. Example brand types may include branded, blind brand, co-brand, and private brand. The branded brand type may be a default brand type, which may be used for some partners or when no partner ID is specified. The blind brand type may be associated with a brand type where the partner prepares a page with their own header and footer information, where page content from the web server farm 102 may be inserted in the partner's page between the header and footer information. As an example, a user may be looking at a web page for one of Insurance Corp's partners. The partner's web page may have a link that takes users to an auto insurance page. When the user clicks on this link, a page may be retrieved from the partner's server, where the retrieved page includes the partner's header and footer information. Additionally, the partner's page may include a pointer to the web server farm 102 (FIG. 1), where an auto application form may be retrieved from the web server farm 102 and inserted into the partner's page.

The co-brand type may be used when a partner's logo appears on any page created by Insurance Corp. As an example, when a partner has a co-branded brand type with Insurance Corp., the partner's logo may appear next to one or in place of Insurance Corp.'s brand logo. The private brand type may be used when the partner may have custom header and footer information. As an example, when a partner has a private brand relationship with Insurance Corp., Insurance Corp's header and footer information may be replaced with the partner's custom header and footer information.

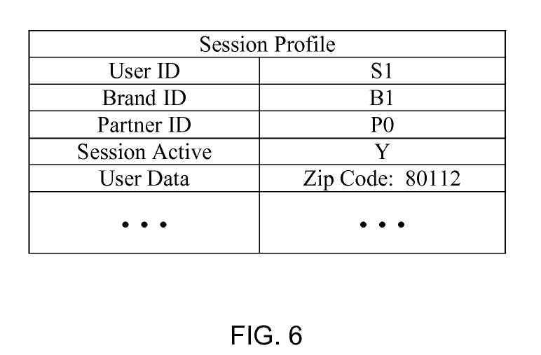

FIG. 6 illustrates an example session profile that may be created by the session module 304 (FIG. 3). In embodiments, the session profile may include a session ID, a brand ID, and a partner ID. For example, the session ID illustrated in FIG. 6 is S1, the brand ID is B1, and the partner ID is P0. As illustrated in FIG. 6, the session profile is created for a user requesting a page associated with Brand X. In embodiments, a session may be terminated if a user fails to request a page from the web server farm 102 (FIG. 1) within a predetermined period of time. Additionally, the session profile may include one or more data items a user entered into a web page such as the user's zip code.

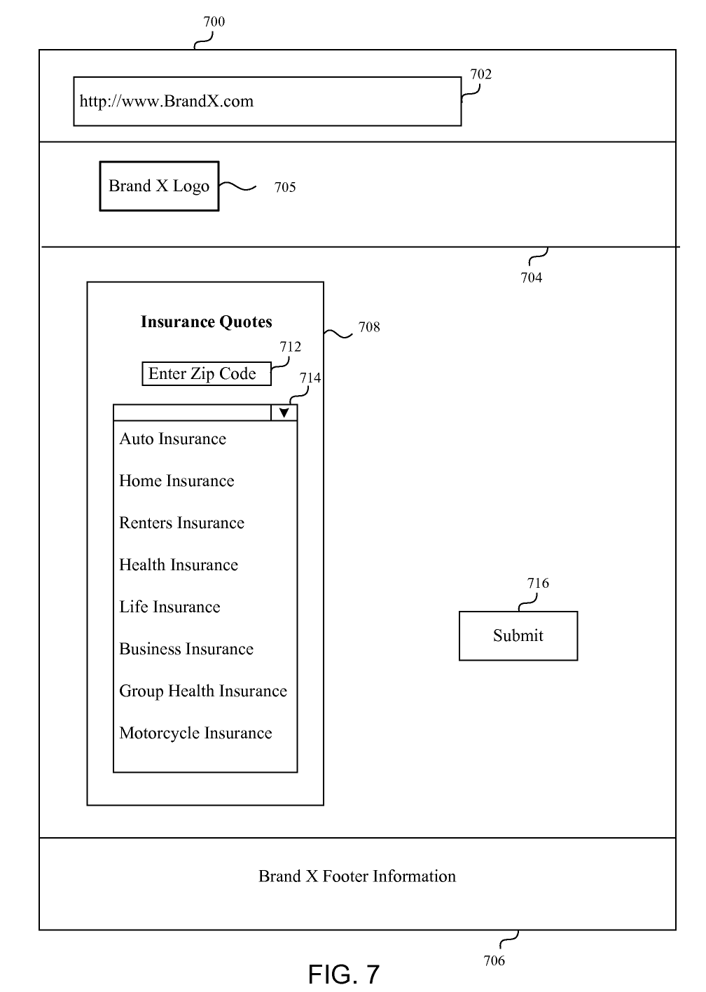

FIG. 7 illustrates an example homepage 700 associated with the domain name www.BrandX.com. The browser may include an URL entry box 702 for entering andto Bror displaying a URL. The homepage 700 may include a header 704, which includes items such as a logo 705, page title, etc., that is unique to Brand X. Additionally, the homepage may include Brand X's footer information 706 that is unique to Brand X. As an example, the footer information may include a site map, directory, copyright, or any other information that is associated with Brand X. The homepage 700 may further include an insurance section 708 that has a control for entering a zip code 712 and selecting a type of insurance 714. The homepage 700 may also include a submit button control 716.

As an illustrative example, when a user submits a URL request to the web server farm 102 (FIG. 1) with the following URL: http:to Brto Brwww.BrandX.comto Br?partnerID=P0. The URL parsing and parameter module 306 may determine from this URL that the domain name is www.BrandX.com, and that the branding option is type ‘Branded’ from the partner ID P0. The branding and partner module 308 (FIG. 3) may use the domain name to determine that the domain name has brand ID B1 and the payload determinator 310 may determine a homepage located at page ID 170 in the database 104. Accordingly, the resources access module 312 may retrieve all items for the page ID 170.

Additionally, the page may contain the content and controls used for the insurance quotes section 708. As an example, the page may include a Zip Code Control that displays the zip code box 712 and has the logic to receive a zip code entered by a user and verify that the entered zip code is correct. Additionally, the page may include an Insurance Types Control that displays the drop down box 714 and includes logic to query database 104 (FIG. 1) to determine which insurance types (e.g., auto, homeowner, etc.) is associated with Brand X. In embodiments, the build page module 314 iterates through each control specified for the page to populate the homepage 700. For example, when the build page module 314 operates on the Insurance Types Control 714 and queries the database 104 (FIG. 1), the build page module may populate the drop down box 714 with insurance types associated with Brand X.

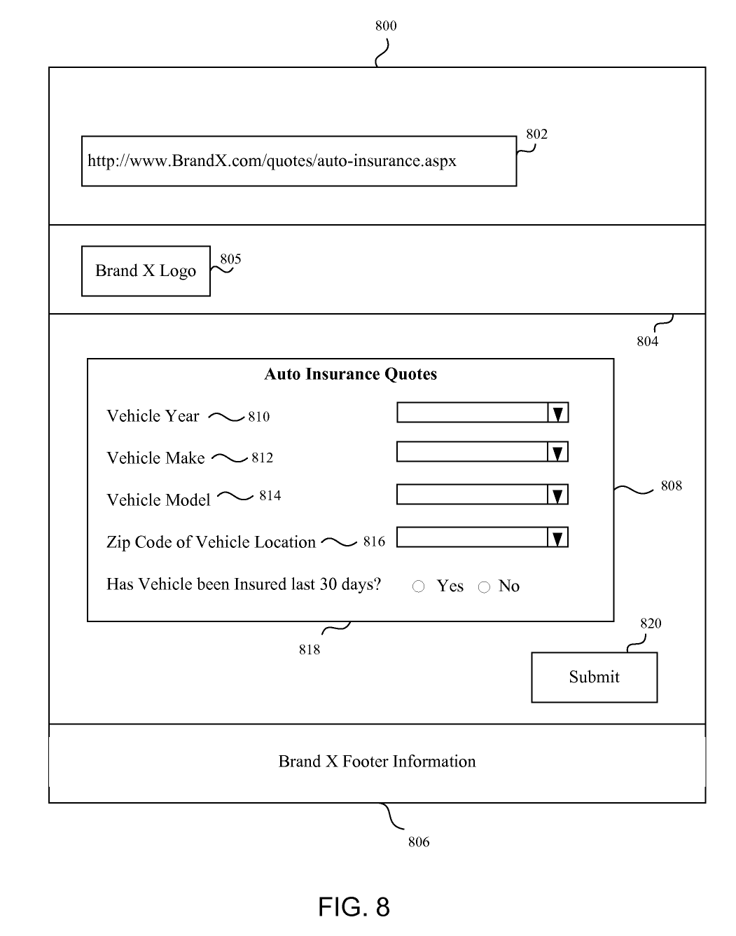

A user viewing the homepage 700 for Brand X may enter a zip code and click the submit button control 716 to enter information in other pages and eventually receive quotes for auto insurance. FIG. 8 illustrates an example auto insurance page 800 associated with Brand X. The auto insurance page 800 may be associated with the URL: http:to Brto Brwww.BrandX.comto Brquotesto Brauto-insurance.aspx. The URL parsing and parameter module 306 may identify www.BrandX.com as a domain name, to Brquotesto Br as a path, and auto-insurance.aspx as a filename. As illustrated in the auto insurance page 800, there may be a browser box 802 for entering or displaying a URL address. The insurance page 800 may include a header 804, which includes items such as logo 805, page title, etc., that is unique to Brand X. The insurance page 800 may further include Brand X's footer information 806. Auto insurance page 800 may also include an auto insurance section 808 for entering information for auto insurance quotes. The insurance quotes section 808 may specify entries for a vehicle year 810, a vehicle make 812, a vehicle model 814, a zip code of the vehicle location 816, and indicate whether the vehicle has been previously insured 818. Auto insurance page 800 may include a submit button 820, which may be executed upon entering information in the auto insurance section 808.

The auto insurance page 800 may have a design of an auto insurance quote application that implements the auto insurance section 808. The auto insurance application may include one or more of the following controls:

Vehicle Year Control

Vehicle Make Control

Vehicle Model Control

Zip Code Control

Previous Insurance Control

The Vehicle Year Control may include logic that is configured to query the database 104 to determine available years for vehicles that may receive insurance. The Vehicle Make Control may include logic that is configured to query the database 104 to determine which vehicle makes (e.g., Toyota, Audi, etc.) are eligible to receive insurance. The vehicle model control 814 may include logic that is configured to query the database 104 to determine vehicle models (e.g., 4-door, all wheel drive, etc.) eligible to receive insurance. Further, the Zip Code Control may be identical to the Zip Code Control for the homepage 700 (FIG. 7), but may be further configured through the skin file to refer to where the applicant's car is parked instead of the applicant's contact address. Accordingly, the auto insurance page 800 (FIG. 8) illustrates how controls may be reused in different pages. In embodiments, controls may be reused in any page of any website. The Previous Insurance Control may include functionality to determine if a vehicle has been insured in the last 30 days. In embodiments, the build page module 314 may iterate through each control in the Brand X Auto Insurance Application to populate the auto insurance section 808 of the auto insurance page 800.

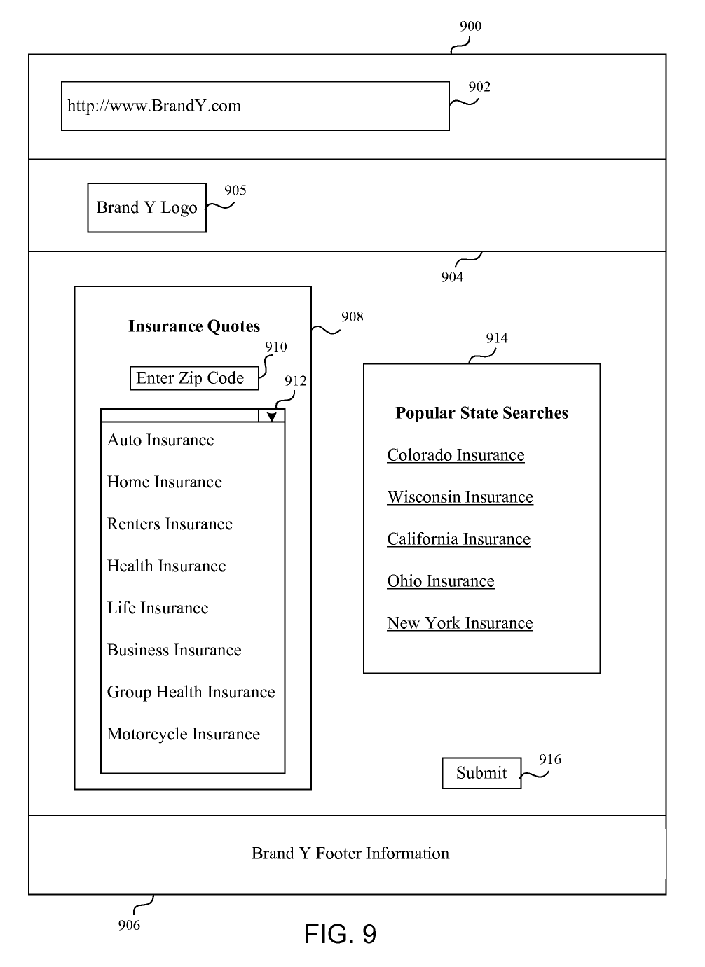

A user may alternatively request a web site of Insurance Corp that displays Brand Y instead of Brand X. FIG. 9 illustrates an example homepage 900 for Brand Y. The homepage 900 may include a browser box 902 that may be similar to the browser box 702 (FIG. 7). The homepage 900 may include a header 904, which includes items such as logo 905, page title, etc., that is unique to Brand Y. The homepage 900 may further include Brand Y's footer information 906 associated with Brand Y. The footer information 906 may be different than the footer information 706 (FIG. 7) for Brand X. For example, the footer information 906 may have a different copyright notice than the footer information 706. Additionally, the homepage 900 may include an insurance section 908 that may include identical controls as the insurance section 708 of Brand X. Accordingly, pages 700 and 900 demonstrate the ability to reuse the same controls in different web pages.

Additionally, in contrast to the homepage 700 (FIG. 7) for Brand X, the homepage 900 may include a popular state searches section 914. As an example, the popular state searches 914 may include a control that has logic configured to query the database 104 to determine which states have received the most requests for insurance quotes and insert dynamic links in the homepage 900 for these states. The homepage 900 may further include a submit button 916.

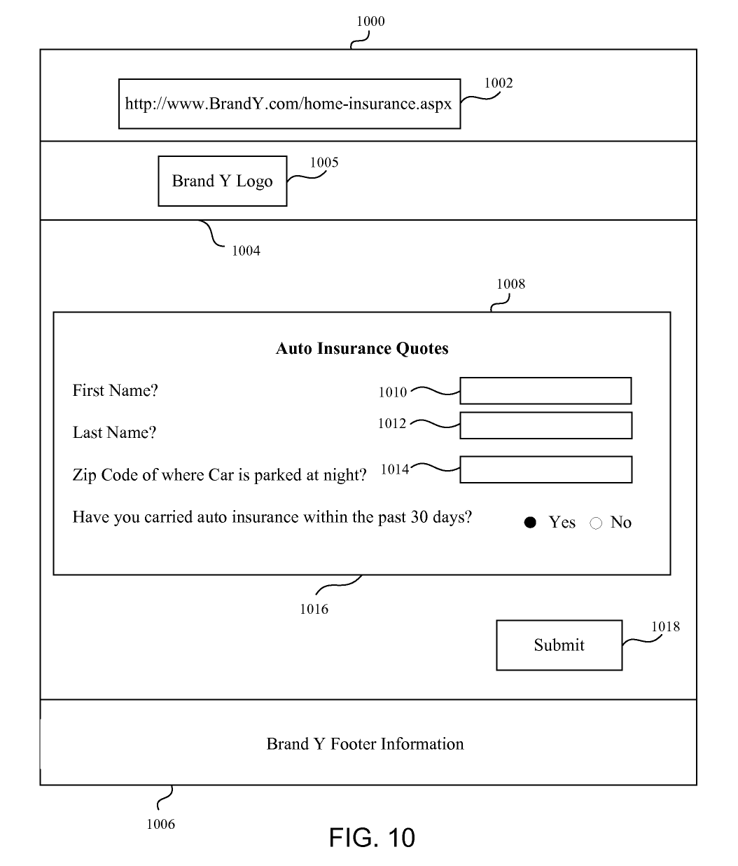

A user accessing the homepage 900 may select to receive auto insurance quotes. FIG. 10 illustrates an example insurance page 1000 for Brand Y. The auto insurance page may include a browser box 1002 that may be identical to the browser box 702 (FIG. 7). The insurance page 1000 may include a header 1004, which includes items such as logo 1005, page title, etc. that is unique to Brand Y. The insurance page 1000 may include Brand Y's footer information 1006. FIG. 10 may include an insurance section 1008 that is different than the auto insurance section 808 (FIG. 8) for Brand X. As an example, the auto insurance section 1008 may include a first name section 1010, a last name section 1012, a zip code section 1014, and a previous insurance section 1016. The auto insurance page 1000 may also include a submit button 1018 which may be executed upon filling in the auto insurance section 1008.

The auto insurance page 1000 may have a design of an auto insurance quote application that implements the auto insurance section 1008. The auto insurance application may include one or more of the following controls:

First Name Control

Last Name Control

Zip Code Control (Entered Zip Code)

Previous Insurance Control

The Zip Code Control and the Previous Insurance Control may be similar to the Zip Code Control and Previous Insurance Control for Brand X Auto Insurance Application. However, the Brand Y Auto Insurance Application includes a First Name Control and a Last Name Control, which are not included in the Brand X Auto Insurance Application. Accordingly, the auto insurance page 1000 compared to the auto insurance page 800 (FIG. 8) illustrates how pages that both provide insurance quotes may be different from each other based on the brand presented to the user. Additionally, since the Zip Code Control is used in both pages 800 and 1000, FIGS. 8 and 10 illustrate how controls and their corresponding functions in the function library of the build page module 314 may be reused from one to page to another.

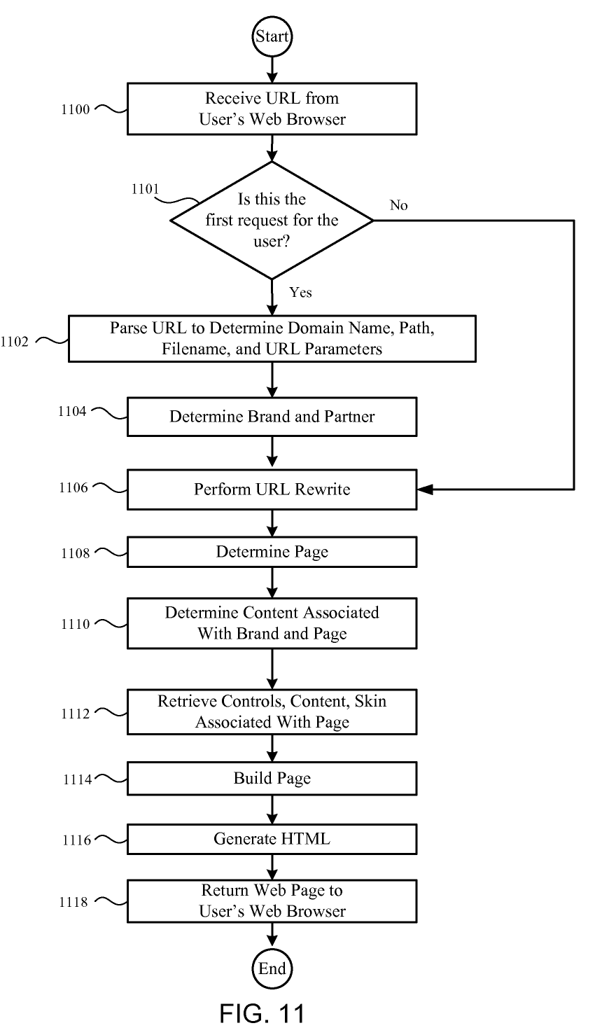

FIG. 11 illustrates an example process for parsing a URL and determining content associated with the parsed URL. The process may generally start at 1100 where a URL from a user's web browser is received. Process flow proceeds to 1101 where it is determined whether the user is requesting a URL for the first time. If the user is requesting the URL for the first time, process flow proceeds from 1101 to 1102 where the URL parsing and parameter module 306 may parse and determine the domain name, path, filename, and URL parameters as functionally described above. If the user's request for the URL is not the user's first request for the URL, process flow proceeds from 1100 to 1106.

Process flow may proceed from 1102 to 1104 to determine the brand and branding options (branded, co-branded, etc.) as functionally described above with respect to FIGS. 4 and 5. Process flow may proceed to 1106 to perform a URL rewrite, which may be performed by the URL rewriting module 302 as functionally described above. Process flow may proceed to 1108 to determine which page to retrieve based on an associated page name. As an example, if a user is requesting to receive auto insurance quotes from Brand X's homepage 700 (FIG. 7), the payload determinator 310 may decide to display a page for the auto insurance page 800 (FIG. 8) for Brand X. Process flow may proceed to 1110 to determine controls and content associated with the determined brand and page.

Process flow may proceed to 1112 to retrieve controls, content, and a skin file associated with the retrieved page. As an example, the resource access module 312 may retrieve the controls, content, and skin file specified in the control template of the page retrieved by the payload determinator 310. Process flow may proceed to 1114 to build the page, where the page module 314 and content enhancement module 316 may iterate through each control and content control, respectively, as functionally described above. Process flow may proceed to 1116 to generate HTML from the built page as functionally described above. Process flow may proceed to 1118 to return the generated web page to the user's web browser.

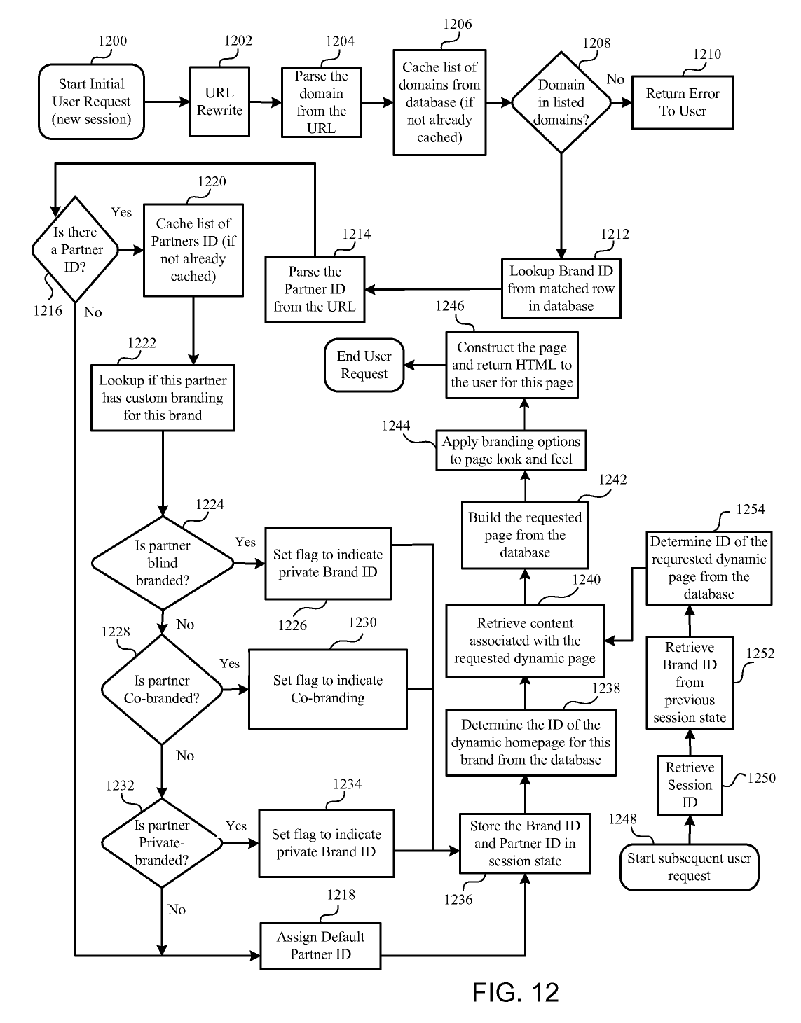

FIG. 12 illustrates an expanded process for parsing a URL and determining content associated with the URL. The process may generally start at 1200 where a new session is created for a user's initial request to the web server farm 102 (FIG. 1). As an example, when the user makes an initial request to the web server farm 102 (FIG. 1), the session module 304 creates the session profile illustrated in FIG. 6 for that user. Process flow proceeds to 1202 a where URL rewrite may be performed by the URL rewriting module 302 (FIG. 3) as functionally described above.

Process flow proceeds to 1204 to parse the domain from the URL as functionally described above. Process flow proceeds to 1206 to cache a list of domains from the database 104 (FIG. 1) if the list of domains is not already cached. As an example, the database 104 (FIG. 1) may contain a list of valid domain names. If these domain names are not already cached in the caches of the web server farm 102, then they are retrieved from the database 104 and placed in the cache of each server in the web server farm 102 to increase the speed of looking up the domain names.

Process flow proceeds to 1208 to determine if the domain name parsed from the URL is in the list of domains. If the domain name is not in the list of domain names, process flow proceeds from 1208 to 1210 to return an error. As an example, if the domain name parsed from the domain from the URL is not listed in the database table illustrated in FIG. 4, an error is returned to the user's web browser. If the domain name parsed from the received URL is listed in the list of domains, process flow proceeds from 1208 to 1212, to look up the brand ID from the matched row in a database as described above with respect to FIG. 4. Process flow proceeds to 1214 to parse the partner ID from the URL as functionally described above.

Process flow proceeds to 1216 to determine if there is a partner ID as functionally described above. If there is no partner ID, process flow proceeds from 1216 to 1218 to assign a default partner ID. Process flow proceeds from 1218 to 1236 to store the brand ID and partner ID in the user's session state. If there is a partner ID parsed from the received URL, process flow proceeds from 1216 to 1220 where the list of partners is cached if not already cached. Process flow proceeds to 1222 to determine if this partner has custom branding for this brand. Process flow proceeds to 1224 to determine if the partner is blind branded. If the partner is blind branded, process flow proceeds to 1226 to set a flag to indicate that the branding option is a specified blind brand. Process flow proceeds from 1226 to 1236 to store the brand ID in the session state. As discussed above, when a partner has a blind brand relationship with Insurance Corp., applications from the web server farm 102 (FIG. 1) may be sent to the partner's server and inserted in the partner's page.

If the partner is not blind branded, process flow proceeds from 1224 to 1228 to determine if the partner is co-branded. If the partner is co-branded, process flow proceeds from 1228 to 1230 to set a flag to indicate co-branding. Process flow proceeds to 1236 to store the brand ID in the session state. As discussed above, when a partner has a co-branded relationship with Insurance Corp., the partner's logo may be inserted next to any one of Insurance Corp.'s brand logos.

If the partner is not co-branded, process flow proceeds from 1228 to 1232 to determine if the partner is private branded. If the partner is not private branded, process flow proceeds from 1232 to 1218 where the process flow described above for 1218 are repeated. If the partner is private branded, process flow proceeds from 1232 to 1234 to set a flag to indicate private branding. The process flow proceeds to 1236 to store the brand ID in the session state. As discussed above, when a partner has a private brand relationship with Insurance Corp., custom headers and footers associated with the partner may be used for any requested page.

Process flow proceeds from 1236 to 1238 to determine the ID of the dynamic homepage for this brand from the database. As an example, referring to FIG. 4, if the user is requesting the home page for Brand X, the page location for that homepage is address 170. Process flow proceeds to 1240 to retrieve the content, controls, and a skin file associated with the requested dynamic page. Process flow proceeds to 1242 to build the requested page from the database, where the build page module 314 and content enhancement module 316 may iterate through each control specified in the requested page as functionally described above. Process flow proceeds to 1244 to apply the branding options to the page as functionally described above. Process flow proceeds to 1246 to construct the page and return HTML to the user for this page as functionally described above. The process in FIG. 12 may end upon returning a page in HTML to the user.

After each user's initial request to the web server farm 102, the process illustrated in FIG. 12 may resume at 1248 for each user's subsequent request to the web server farm 102. Process flow proceeds from 1248 to 1250 to retrieve the session ID from the user's session state. Process flow may proceed to 1252 to retrieve the brand ID from the previous session state. Process flow may proceed to 1254 to determine the ID of the requested dynamic page from the database. Process flow may proceed from 1254 to 1240, where the process flow described above for 1240 may be repeated.

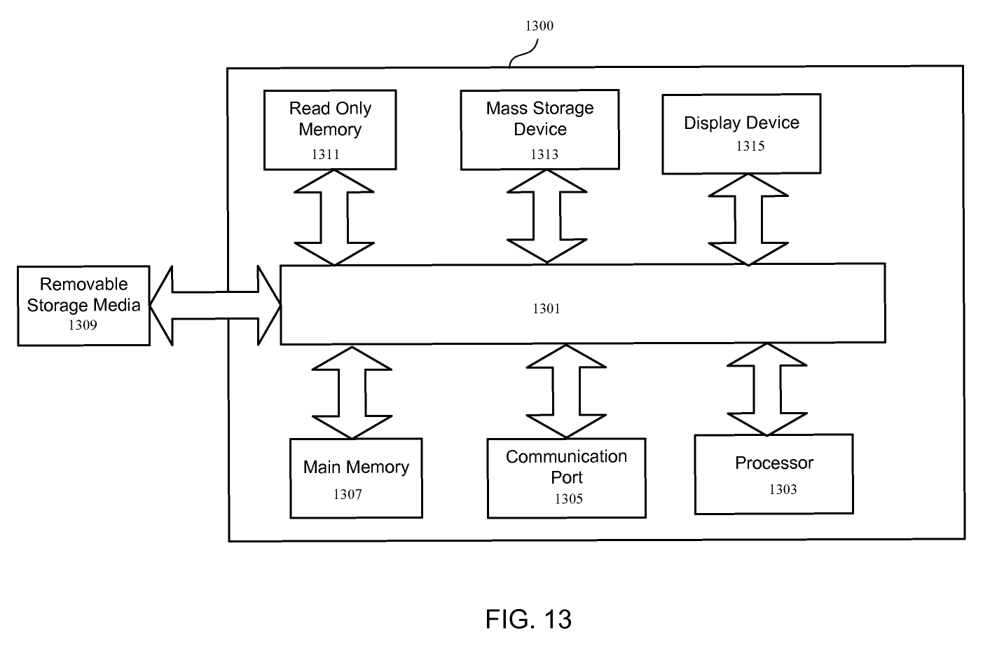

FIG. 13 is a schematic diagram of an example computing device 1300 for inclusion with (and in environments of) embodiments of the present invention. For example, computing device 1300 may be implemented on each of the servers in the web server farm 102 (FIG. 1), in the server system 200 (FIG. 2), andto Bror in the web system 300 (FIG. 3).

In embodiments, the computing device 1300 includes a bus 1301, at least one processor 1303, at least one communication port 1305, a main memory 1307, a removable storage media 1309, a read only memory 1311, a mass storage 1313, and a display device 1315. Processor(s) 1303 can be any know processor, such as, but not limited to, an Intel® Pentium, Itanium® or Itanium 2® processor(s), or AMD®, Opteron® or Athlon MP® processor(s), or Motorola® lines of processors.

Communication port(s) 1305 can be any known communications conduit such as, but not limited to, an RS-232 port for use with a modem based dialup connection, a 10/100 Ethernet port, or a Gigabit port using copper or fiber. Communication port(s) 1305 may be chosen depending on a network such as a Local Area Network (LAN), Wide Area Network (WAN), or any desired network to which the computing device 1300 connects. The computing device 1300 may be in communication with peripheral devices such as, but not limited to, printers, speakers, cameras, microphones, or scanners.

Main memory 1307 can be Random Access Memory (RAM), or any other desired storage device(s). Read only memory 1311 (ROM) can be any suitable storage device(s) such as, but not limited to, Programmable Read Only Memory (PROM) chips for storing static information such as instructions for processor 1303.

Mass storage 1313 can be used to store information and instructions. For example, hard disks such as the Adaptec® family of SCSI drives, an optical disc, an array of disks such as RAID, such as the Adaptec family of RAID drives, or any other mass storage devices may be used. In embodiments, the main memory 1307, removable storage media 1309, read only memory 1311, and mass storage 1313 may each comprise one or more units linked together physically or logically to operate as a single unit.

In embodiments of the present invention, the display device 1315 may be any desired computer monitor such as a Compaq FS7600e or a Dell E157FPT. In additional or overlapping embodiments, the display device 1315 may be an LCD screen of a personal digital assistant (PDA) such as the LCD screens used for the Blackberry 8000 series. In embodiments, the display device 1315 may be external to the computing device 1300.

Bus 1301 communicatively couples processor(s) 1303 with the other memory, storage, and communication blocks. Bus 1301 can be a PCIto BrPCI-X or SCSI based system bus depending on the storage devices used. Removable storage media 1309 can be any kind of external hard-drives, such as, but not limited to, floppy drives, Zip Drives, Compact Disc—Read Only Memory (CD-ROM), Compact Disc—Re-Writable (CD-RW), Digital Video Disk—Read Only Memory (DVD-ROM).

Embodiments can be implemented using a combination of one or more desired programming languages such as, but not limited to, C#, PHP, MySQL, ASP, HTML, Javascript, and Flash.

Various modifications and additions can be made to the exemplary embodiments discussed without departing from the scope of the present invention. For example, while the embodiments described above refer to particular features, the scope of this invention also includes embodiments having different andto Bror additional combinations of features and embodiments that do not include all of the above described features.

The following is claimed:

1. A computer-based system for generating a user-requested resource, comprising:
a web server farm configured to communicate with a network and a content source;
a parse facilitator configured to parse a URL received through the network from a browser of a user computer;
a payload determinator configured to use at least the received URL to identify and retrieve one or more controls from the content source;
a payload constructor configured to retrieve components uniquely associated with the retrieved one or more controls and assemble a user page using the retrieved components,
wherein the payload constructor is used for any unique received URL, and for assembling one or more user pages associated with any unique URL; and
a launch facilitator configured to forward the assembled user page to the browser of the user computer through the network.

2. The computer-based system according to claim 1, wherein the payload constructor is further configured to implement one or more functional content items in the assembled user page.

3. The computer-based system according to claim 1, wherein the URL includes at least a unique domain portion, a path, a filename, and one or more URL parameters, and wherein
the one or more controls correspond to at least the path, the file name, and the one or more URL parameters.

4. The computer-based system according to claim 3, wherein the payload determinator is further configured to use at least the unique domain portion from the received URL to identify and retrieve the one or more controls from the content source.

5. The computer-based system according to claim 1, wherein the launch facilitator is further configured to convert the assembled user page to HTML.

6. The computer-based system according to claim 1, wherein the payload constructor is further configured to assemble the user page by using one or more functions to query the content source for the components, wherein the one or more controls are further configured to invoke the one or more functions.

7. The computer-based system according to claim 6, wherein the one or more functions are configured to query the content source specifying at least one condition, and retrieve the components from the content source that meet the at least one specified condition.

8. The computer-based system according to claim 6, wherein the one or more controls include at least one content control, wherein the at least one content control is configured to specify at least one location for inserting the components retrieved from the content source.

9. The computer-based system according to claim 6, wherein the one or more controls includes at least one verification control, wherein the at least one verification control is configured to compare data entered by the user with the components retrieved from the content source.

10. The computer-based system according to claim 1, wherein the one or more URL parameters include at least a brand ID uniquely associated with the retrieved components.

11. The computer-based system according to claim 10, wherein the one or more URL parameters include at least a partner ID associated with a default brand, co-brand, blind brand, or private brand, wherein
the assembled user page includes a partner logo when the partner ID is associated with the co-brand,
the assembled user page includes a partner specific header provided by the partner when the partner ID is associated with the blind brand, and
the assembled user page includes a custom header when the partner ID is associated with the private brand.

12. A computer-readable medium having instructions stored thereon, the instructions configured to cause one or more processors to instruct:
a web server farm to communicate with a network and a content source;
a parse facilitator to parse a URL received through the network from a browser of a user computer;
a payload determinator to use at least the received URL to identify and retrieve one or more controls from the content source;
a payload constructor to retrieve components uniquely associated with the retrieved one or more controls and assemble a user page using the retrieved components,
wherein the payload constructor is used for any unique received URL, and for assembling one or more user pages associated with any unique URL; and
a launch facilitator to forward the assembled user page to the browser of the user computer through the network.

13. The computer-readable medium according to claim 12, wherein the instructions are further configured to cause the one or more processors to instruct:
the payload constructor to implement one or more functional content items in the assembled user page.

14. The computer-readable medium according to claim 12, wherein the URL includes at least a unique domain portion, a path, a filename, and one or more URL parameters, and wherein
the one or more controls correspond to at least the path, the file name, and the one or more URL parameters.

15. The computer-readable medium according to claim 14, wherein the instructions are further configured to cause the one or more processors to instruct:
the payload determinator to use at least the unique domain portion from the received URL to identify and retrieve the one or more controls from the content source.

16. The computer-readable medium according to claim 12, wherein the instructions are further configured to cause the one or more processors to instruct:
the payload constructor to assemble the user page by using one or more functions to query the content source for the components, wherein the one or more controls are further configured to invoke the one or more functions.

17. The computer-readable medium according to claim 16, wherein the one or more functions are configured to query the content source specifying at least one condition, and retrieve the components from the content source that meet the at least one specified condition.

18. The computer-readable medium according to claim 14, wherein the one or more URL parameters include at least a partner ID associated with a default brand, co-brand, blind brand, or private brand, wherein
the assembled user page includes a partner logo when the partner ID is associated with the co-brand,
the assembled user page includes a partner specific header provided by the partner when the partner ID is associated with the blind brand, and
the assembled user page includes a custom header when the partner ID is associated with the private brand.

19. A computer-implemented method for generating a user-requested resource, the method comprising:
communicating, using one or more servers, with a network and a content source;
receiving a URL from the network from a browser of a user computer;
identifying and retrieving, using a parse facilitator, one or more controls from the content source using at least the received URL;
retrieving, by a payload constructor, components uniquely associated with the retrieved one or more controls;
assembling, by the payload constructor, a user page using the retrieved components,
wherein the payload constructor is used for any unique received URL, and for assembling one or more user pages associated with any unique URL; and
forwarding, by a launch facilitator, the assembled user page to the browser of the user computer through the network.

20. The computer-implemented method according to claim 19, further comprising:
implementing, by the payload constructor, one or more functional content items in the assembled user page.

21. The computer-implemented method according to claim 19, wherein the URL includes at least a unique domain portion, a path, a filename, and one or more URL parameters, and wherein
the one or more controls correspond to at least the path, the file name, and the one or more URL parameters.

22. The computer-implemented method according to claim 21, wherein the identifying and retrieving, the one or more controls from the content source further comprises:
using at least the unique domain portion from the received URL to identify and retrieve the one or more controls from the content source.

23. The computer-implemented method according to claim 19, wherein the assembling the user page further comprises:
using one or more functions to query the content source for the components, wherein the one or more controls are further configured to invoke the one or more functions.

24. The computer-implemented method according to claim 23, wherein the one or more functions are configured to query the content source specifying at least one condition, and retrieve the components from the content source that meet the at least one specified condition.

25. The computer-implemented method according to claim 21, wherein the one or more URL parameters include at least a partner ID associated with a default brand, co-brand, blind brand, or private brand, wherein
the assembled user page includes a partner logo when the partner ID is associated with the co-brand,
the assembled user page includes a partner specific header provided by the partner when the partner ID is associated with the blind brand, and
the assembled user page includes a custom header when the partner ID is associated with the private brand.
